(19) United States
(12) Patent Application Publication
(10) Pub. No.: US 2014/0139378 A1
(43) Pub. Date: May 22, 2014

(54) MONOPOLE ANTENNA

(71) Applicant: ARCADYAN TECHNOLOGY CORPORATION, Hsinchu City (TW)

(72) Inventors: CHIH-YUNG HUANG, Taichung County (TW); KUO-CHANG LO, Miaoli County (TW)

(73) Assignee: ARCADYAN TECHNOLOGY CORPORATION, Hsinchu City (TW)

(21) Appl. No.: 14/081,133

(22) Filed: Nov. 15, 2013

(30) Foreign Application Priority Data
Nov. 20, 2012 (TW) 101143278

(51) Int. Cl. H01Q 1/38

(52) U.S. Cl. CPC H01Q 1/38
USPC 343/700 MS

(57) ABSTRACT

The monopole antenna comprises an antenna body comprising a first radiation portion and a second radiation portion comprising a feed-in terminal, wherein the first radiation portion has a length and a width extending respectively in a first direction and a second direction, the first direction is perpendicular to the second direction, and the first radiation portion is connected to the second radiation portion in the first direction; a dielectric part, coupled to the antenna body; and a ground part, coupled to the dielectric part for enabling the dielectric part to isolate the antenna body from the ground part; wherein the length of the first radiation portion is adjusted to adjust operation frequency of the antenna body, the width of the first radiation portion is adjusted to adjust operation bandwidth of the antenna body, and size of the second radiation part is adjusted to adjust impedance matching of the antenna body.

### FIELD OF THE INVENTION

The present invention relates to a monopole antenna, and more particularly, to a printed monopole antenna.

### BACKGROUND OF THE INVENTION

Nowadays, antenna is becoming an essential part for wireless products, such as cellular phones, notebook computers or wireless network interface cards, that is to be used for data transmission and receiving operations. Conventionally, the design of an antenna for wireless devices is generally determined and restricted by product specifications including space availability, characteristic requirements and manufacture cost. Consequently, according to the use of different frequency bands in antennas, the antennas currently used in wireless devices can be divided into single-band antennas, dual-band antennas, multi-band antennas and broadband antennas, and moreover, it can also be divided into chip antennas and printed antennas according to structural difference. In addition, the printed antennas which includes monopole antennas, dipole antennas, planar inverted-F antennas (PIFA), and loop antenna are featured by their comparative larger area occupation, lower manufacturing cost and wider bandwidth, whereas the chip antennas are exactly the opposite. It is noted that there are already a variety of planar inverted-F antennas or monopole antennas available on the market that are designed for allowing satisfactory transceiving performance and compactness in structure while capable of being attached easily onto an internal surface of handheld electronic devices, and thus they are already being applied vastly in many handheld electronic devices for wireless communication, such as notebook computers, access points and cellular phones.

Conventionally, a signal feed point and a signal ground of a PIFA are connected respectively to the inner conductive layer and the outer conductive layer of a coaxial cable, by that signals that are to be transmitted can be outputted through the PIFA. Nevertheless, as the bandwidth of PIFA is generally narrow, the PIFA is required to be fine-tuned for adapting to different environments. It is noted that the most traditional and the most classic antenna design is the monopole antenna, as shown in FIG. 1. In FIG. 1, a conventional monopole antenna 1 is coupled and fixed to a substrate 12 by a supporting part 11. However, such monopole antenna 1 that is only supported by the supporting part 11 can tilted easily in any direction, not to mention that it is difficult to fix, difficult and also expensive to manufacture.

Therefore, it is in need of an improved monopole antenna without the aforesaid shortcomings

### SUMMARY OF THE INVENTION

The object of the present invention is to provide a monopole antenna that can be adapted for different operation environments, and thus can be shared between multiple systems for lowering the manufacturing cost effectively.

Another object of the invention is to provide a monopole antenna, being an antenna formed on a circuitboard by printing, by that the conventional cost required for producing molds of three-dimensional antenna parts and also for assembling the same can be reduced.

The present invention provides a monopole antenna, which comprises: an antenna body; a dielectric part; and a ground part; wherein the antenna body further comprises: a first radiation portion, formed with a first length and a first width that are extending respectively in a first direction and a second direction, while the first direction is perpendicular to the second direction; and a second radiation portion having a feed-in signal terminal; the first radiation portion is connected to the second radiation portion in the first direction; the dielectric part is coupled to the antenna body, while the ground part is coupled to the dielectric part for allowing the dielectric part to isolate the antenna body from the ground part; the operation frequency of the antenna body is adjustable according to the adjusting to the first length of the first radiation portion, while the operation bandwidth of the antenna body is adjustable according to the adjusting to the first width of the first radiation portion, and the impedance matching of the antenna body is adjustable according to the adjusting to the size of the second radiation part.

Preferably, the first radiation portion is formed as a rectangular part with a length about equal to one quarter of the resonant wavelength of an operating frequency defined within a predetermined frequency band.

Preferably, the antenna body has four sides, and three of the four sides are arranged coupling to the dielectric part while allowing the ground part to be disposed coupling to the dielectric part at positions corresponding to the three sides.

Preferably, the second radiation portion is formed with a second length and a second width that are extending also respectively in the first direction and the second direction, and the first length is longer than the second length while the first width is wider than the second width.

Preferably, the impedance matching of the antenna body is adjustable according to the adjusting to the second length and/or the second width.

Preferably, the impedance matching of the antenna body is adjustable according to the adjusting to a first distance formed along the first direction between the first radiation portion and the ground part.

Preferably, the impedance matching of the antenna body is adjustable according to the adjusting to a second distance formed along the first direction between the second radiation portion and the ground part.

Preferably, the second distance is larger than the first distance.

Preferably, the second radiation portion is formed as a radiation portion of inverted-F shape, and thus the impedance matching of the antenna body is adjustable according to the adjusting to the size of the inverted-F radiation portion.

Preferably, the second radiation portion is formed as a radiation portion of inverted-F shape, which comprises: a first extending part extending toward the ground part in the second direction; and a second extending part; the first extending part is located at the end of the second extending part while allowing the second extending part to be disposed at a position between the first extending part and the first radiation portion; and thus the impedance matching of the antenna body is adjustable according to the adjusting to the size of the first extending part and/or the size of the second extending part.

Preferably, there is a first slot hole formed between the first extending part and the second extending part, while there is a second slot hole formed between the second extending part and the first radiation portion; and thus the impedance matching of the antenna body is adjustable according to the adjusting to the size of the first slot hole and/or the size of the second slot hole.

Preferably, the feed-in signal terminal is included in the second extending part of the second radiation portion and is provided for receiving a feed-in signal from the monopole antenna.

Preferably, the monopole antenna further comprises: a printed circuitboard, formed with a first surface and a second surface that are arranged corresponding to each other; wherein, the antenna body, the dielectric part and the ground part are disposed on the first surface, while allowing no circuit or component to be disposed at an area on the second surface corresponding to the projection of the antenna body.

Preferably, the antenna body is disposed at a position neighboring to a side of the printed circuitboard.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic view of a conventional monopole antenna.

FIG. 2 is a schematic view of a monopole antenna according to an embodiment of the present invention.

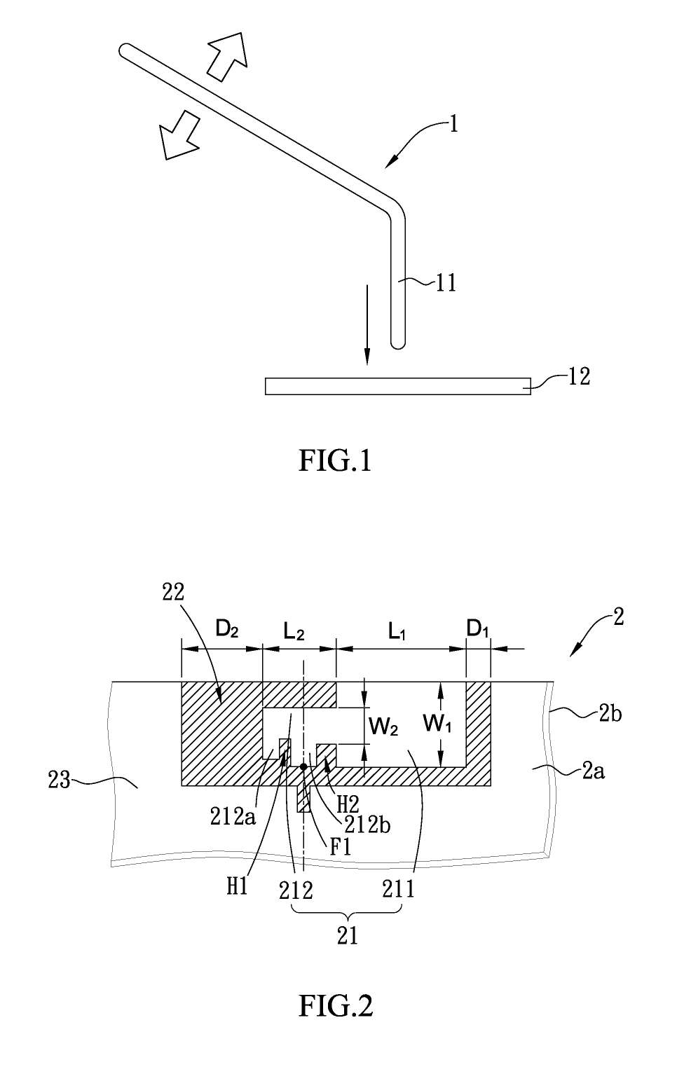

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

Please refer to FIG. 2, which is a schematic view of a monopole antenna according to an embodiment of the present invention. In FIG. 2, the monopole antenna is disposed on a print circuitboard 2, which is formed with a first surface 2a and a second surface 2b. Moreover, the monopole antenna is composed of an antenna body 21, a dielectric part 22 and a ground part 23 in a manner that the antenna body 21, the dielectric part 22 and the ground part 23 are disposed together on the first surface 2a of the printed circuitboard 2, while allowing no circuit or component to be disposed at an area on the second surface 2b corresponding to the projection of the antenna body 21. In addition, the antenna body 21 is disposed at a position neighboring to a side of the printed circuitboard 2.

The antenna body 21 further comprises: a first radiation portion 211, formed with a first length L₁ and a first width W₁ that are extending respectively in a first direction and a second direction, while the first direction is perpendicular to the second direction; and a second radiation portion 212, having a feed-in signal terminal F₁. Moreover, the first radiation portion 211 is connected to the second radiation portion 212 in the first direction, and the operation frequency of the antenna body 21 is adjustable according to the adjusting to the first length L₁ of the first radiation portion 211, while the operation bandwidth of the antenna body 21 is adjustable according to the adjusting to the first width W₁ of the first radiation portion 21, and the impedance matching of the antenna body 21 is adjustable according to the adjusting to the size of the second radiation part 212. In addition, the second radiation portion 212 can be formed with a second length L₂ and a second width W₂ that are extending also respectively in the first direction and the second direction, and similarly the impedance matching of the antenna body 21 is adjustable according to the adjusting to the second length L₂ or the second width W₂. In this embodiment, the first length L₁ is longer than the second length L₂ while the first width W₁ is wider than the second width W₂. It is noted that the second radiation portion 212 is formed as a radiation portion of inverted-F shape, and thus the impedance matching of the antenna body 21 is adjustable according to the adjusting to the size of the inverted-F radiation portion 212.

The dielectric part 22 is coupled to the antenna body 21, while the ground part 23 is coupled to the dielectric part 22 for allowing the dielectric part 22 to isolate the antenna body 21 from the ground part 23. In this embodiment, the first radiation portion 211 is formed as a rectangular part, so that the impedance matching of the antenna body 21 is adjustable according to the adjusting to a first distance D₁ formed along the first direction between the first radiation portion 211 and the ground part 23, and/or the adjusting to a second distance D₂ formed along the first direction between the second radiation portion 212 and the ground part 23, while the second distance D₂ is larger than the first distance D₁.

Moreover, the second radiation portion 212 further comprises: a first extending part 212a, extending toward the ground part 23 in the second direction; and a second extending part 212b; in which the first extending part 212a is located at the end of the second extending part 212b while allowing the second extending part 212b to be disposed at a position between the first extending part 212a and the first radiation portion 211; and thus the impedance matching of the antenna body 21 is adjustable according to the adjusting to the size of the first extending part 212a and/or the size of the second extending part 212b. In this embodiment, the second extending part 212b is formed longer and wider than the first extending part 212a. Moreover, the feed-in signal terminal F₁ is included in the second extending part 212b of the second radiation portion 212 and is located corresponding to a feed-in point or connected to a transmission line so as to be provided for receiving a feed-in signal from the monopole antenna.

In addition, there is a first slot hole H₁ formed between the first extending part 212a and the second extending part 212b, while there is a second slot hole H₂ formed between the second extending part 212b and the first radiation portion 211; and thus the impedance matching of the antenna body 21 is adjustable according to the adjusting to the size of the first slot hole H₁ and/or the size of the second slot hole H₂.

In this embodiment, the antenna body 21 has four sides, and three of the four sides are arranged coupling to the dielectric part 22 while allowing the ground part 23 to be disposed coupling to the dielectric part 22 at positions corresponding to the three sides. The aforesaid ground part 23 can be made of a metal, and the monopole antenna can be a single-frequency monopole antenna adapted for a wireless communication field, such as IEEE 802.11a/b/c/g, or a band ranged between 5.15 GHz and 5.85 GHz.

In this embodiment, the printed circuitboard 2 can be a dielectric substrate having a surface provided for the monopole antenna to be disposed thereat, and moreover, the surface with the monopole antenna further has a grounded metal layer and a non-metallic layer formed thereat. Thus, at an area on another surface of the dielectric substrate that is located corresponding the area with metallic lines, there has no metal layer being disposed thereat. It is noted that the second extending part 212b of the antenna body 21 can similarly be used as the feed-in signal terminal F₁ while enabling the first extending part 212a to be the extension of the ground part 23. Moreover, the first radiation portion 211 of the antenna body 21 is formed with a first length L₁ about equal to one quarter of the resonant wavelength of an operating frequency defined within a predetermined frequency band, so that the first radiation portion 211 is substantially the signal radiating portion of the monopole antenna. In addition, the impedance matching of the monopole antenna is adjustable according to the adjusting to the second length L₂ of the second radiation portion 212, by that the VSWR of the antenna can be adjusted to meet with the required industry specifications. Moreover, since the monopole antenna of the present invention is designed without the additional ground end as that of the conventional PIFAs, the size of the present invention is actually smaller than those of the conventional PIFAs, and as monopole antenna of the present invention is enabled to operated in a signal feed-in manner via a 50 Ω transmission line that is coupled directly to the circuitboard, by that the cost of using cable for signal feed-in can be waived, and also the cost required for producing molds of three-dimensional antenna parts and for assembling the same can be waived.

The monopole antenna of the present invention is a built-in antenna adapted for all kinds of wireless communication devices that can be adjusted and modified to meet with any product specifications. In addition, the monopole antenna of the present invention can be adapted for device operating in WiFi 802.11a protocol (5.15˜5.85 GHz), such as notebook computers, cellular phones, WiFi TVs, and DVDs. In addition, the monopole antenna of the present invention not only can be shared between multiple systems, but also can be formed by printing directly on a circuitboard, so that the cost required for producing molds of three-dimensional antenna parts and for assembling the same can be reduced.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A monopole antenna, comprising:
an antenna body, further comprising:
a first radiation portion, formed with a first length and a first width that are extending respectively in a first direction and a second direction, while allowing the first direction to be perpendicular to the second direction; and
a second radiation portion, having a feed-in signal terminal;
a dielectric part, coupled to the antenna body; and
a ground part, coupled to the dielectric part for allowing the dielectric part to isolate the antenna body from the ground part;
wherein, the first radiation portion is connected to the second radiation portion in the first direction; the operation frequency of the antenna body is adjustable according to the adjusting to the first length of the first radiation portion, while the operation bandwidth of the antenna body is adjustable according to the adjusting to the first width of the first radiation portion, and the impedance matching of the antenna body is adjustable according to the adjusting to the size of the second radiation part.

2. The monopole antenna of claim 1, wherein the first radiation portion is formed as a rectangular part; the impedance matching of the antenna body is adjustable according to the adjusting to a first distance formed along the first direction between the first radiation portion and the ground part, and/or the adjusting to a second distance formed along the first direction between the second radiation portion and the ground part, while the second distance is larger than the first distance.

3. The monopole antenna of claim 1, wherein the second radiation portion is formed as a radiation portion of inverted-F shape, and thus the impedance matching of the antenna body is adjustable according to the adjusting to the size of the inverted-F radiation portion.

4. The monopole antenna of claim 1, wherein the second radiation portion is formed with a second length and a second width that are extending also respectively in the first direction and the second direction, and the first length is longer than the second length while the first width is wider than the second width.

5. The monopole antenna of claim 1, wherein the second radiation portion is formed as a radiation portion of inverted-F shape, which comprises: a first extending part extending toward the ground part in the second direction; and a second extending part; the first extending part is located at the end of the second extending part while allowing the second extending part to be disposed at a position between the first extending part and the first radiation portion; and thus the impedance matching of the antenna body is adjustable according to the adjusting to the size of the first extending part and/or the size of the second extending part.

6. The monopole antenna of claim 5, wherein the feed-in signal terminal is included in the second extending part of the second radiation portion and is provided for receiving a feed-in signal from the monopole antenna.

7. The monopole antenna of claim 5, wherein there is a first slot hole formed between the first extending part and the second extending part, while there is a second slot hole formed between the second extending part and the first radiation portion; and thus the impedance matching of the antenna body is adjustable according to the adjusting to the size of the first slot hole and/or the size of the second slot hole.

8. The monopole antenna of claim 1, further comprising:
a printed circuitboard, formed with a first surface and a second surface that are arranged corresponding to each other;
wherein, the antenna body, the dielectric part and the ground part are disposed on the first surface.

9. The monopole antenna of claim 8, wherein no circuit or component is allowed to be disposed at an area on the second surface corresponding to the projection of the antenna body

10. The monopole antenna of claim 8, wherein the antenna body is disposed at a position neighboring to a side of the printed circuitboard.

11. The monopole antenna of claim 1, being a single-frequency monopole antenna adapted for a wireless communication field.
